(19) United States
(12) Patent Application Publication
(10) Pub. No.: US 2026/0061911 A1
(43) Pub. Date: Mar. 5, 2026

(54) VEHICLE ARMREST DEVICE

(71) Applicant: Todd E. Smith, Cincinnati, OH (US)

(72) Inventor: Todd E. Smith, Cincinnati, OH (US)

(21) Appl. No.: 18/816,348

(22) Filed: Aug. 27, 2024

(51) Int. Cl. B60N 2/75

(52) U.S. Cl. CPC B60N 2/787

(57) ABSTRACT

A vehicle armrest device for supporting a driver's arms while the driver is driving a vehicle includes a support strap that is positionable around a backrest of a seat in a vehicle. A first armrest is attached to the support strap thereby enabling the first armrest to be positioned upon a center console of the vehicle to support a driver's right arm when the driver is seated in the seat. A second armrest is attached to the support strap thereby enabling the second armrest to be positioned between the seat and a driver's side door of the vehicle to support the driver's left arm when the driver is seated in the seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to armrest devices and more particularly pertains to a new armrest device for supporting a driver's arms while the driver is driving a vehicle. The device includes a support strap that is positionable around a backrest of a seat in a vehicle and a first armrest attached to the support strap and a second armrest attached to the support strap. The first armrest is positionable on a center console of the vehicle and the second armrest is positionable on an arm rest of a driver's side door of the vehicle thereby enabling the driver's left arm and the right arm to be comfortably supported while the driver is driving the vehicle.

### (2) Description of Related Art Including Information Disclosed Under 37 CFR 1.97 and 1.98

The prior art relates to armrest devices including a variety of vehicle pillow devices that each at least includes a cushion for a center console of a vehicle for supporting a driver's left arm and a variety of vehicle pillow devices that each at least includes a cushion that is positionable on an arm rest of a driver's side door of a vehicle for supporting a driver's left arm and a vehicle cushion device that includes a pair of leg cushions that are attached together with a band to enable each of the leg cushions to be positioned next to each of a driver's legs for cushioning the driver's legs while the driver is driving. In no instance does the prior art disclose a vehicle arm rest device that includes a support strap that is positionable around a backrest of a seat in a vehicle and a first armrest attached to the support strap that is positionable on a center console of the vehicle and a second armrest attached to the support strap that is positionable on an arm rest of a driver's side door of the vehicle for supporting each of a driver's arms.

### BRIEF SUMMARY OF THE INVENTION

An embodiment of the disclosure meets the needs presented above by generally comprising a support strap that is positionable around a backrest of a seat in a vehicle. A first armrest is attached to the support strap thereby enabling the first armrest to be positioned upon a center console of the vehicle to support a driver's right arm when the driver is seated in the seat. A second armrest is attached to the support strap thereby enabling the second armrest to be positioned between the seat and a driver's side door of the vehicle to support the driver's left arm when the driver is seated in the seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a vehicle armrest device according to an embodiment of the disclosure.

FIG. 2 is a front view of an embodiment of the disclosure.

FIG. 3 is a back side view of an embodiment of the disclosure.

FIG. 4 is a right side view of an embodiment of the disclosure.

FIG. 5 is a top in-use view of an embodiment of the disclosure.

### DETAILED DESCRIPTION OF THE INVENTION

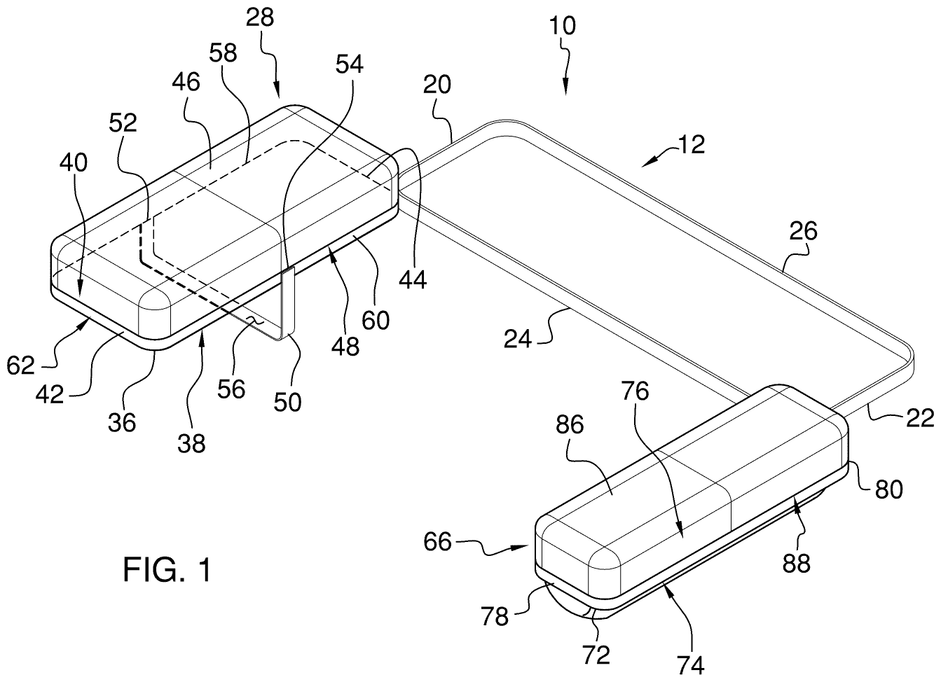

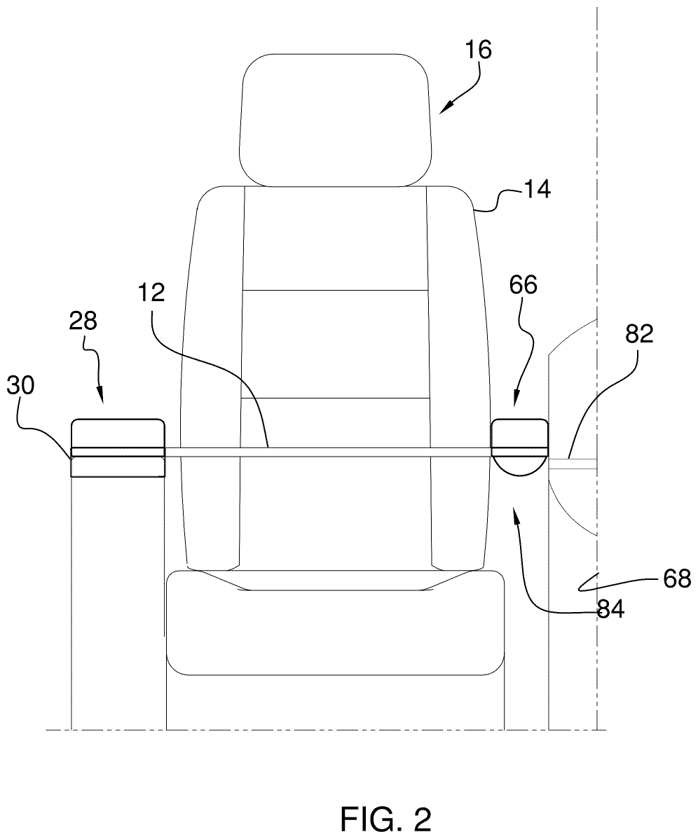

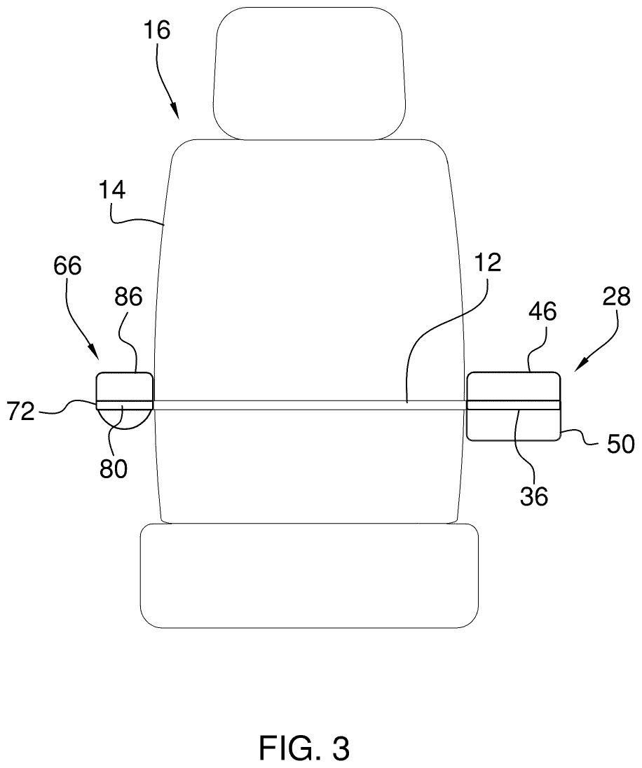

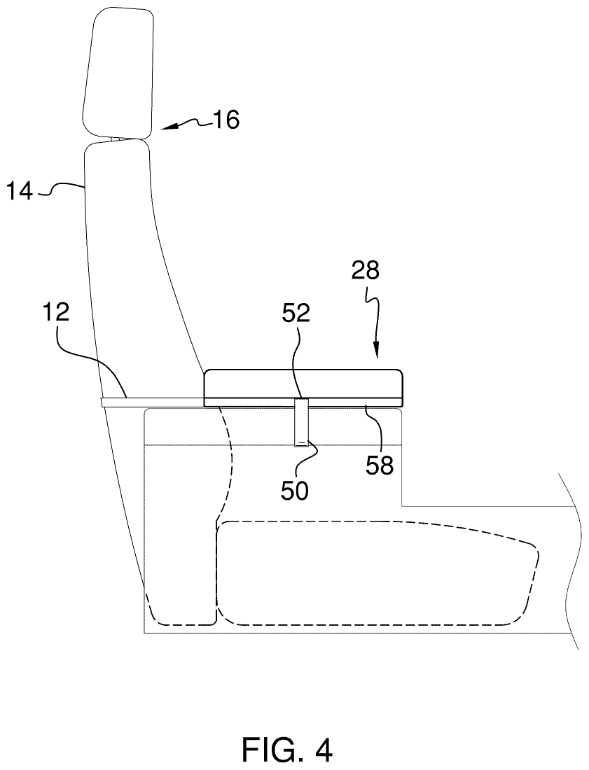

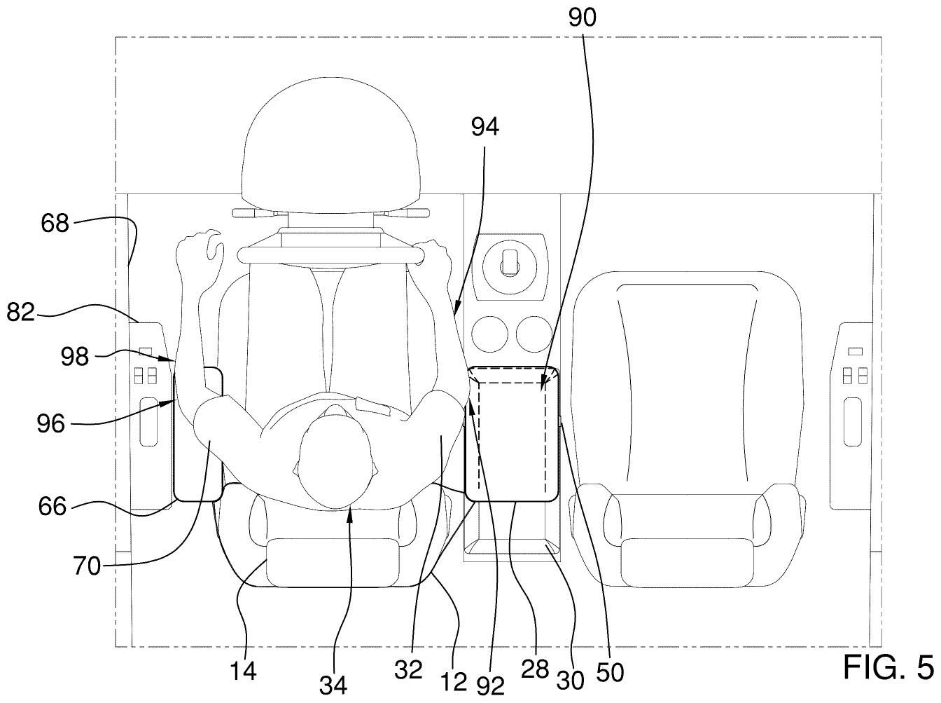

With reference now to the drawings, and in particular to FIGS. 1 through 5 thereof, a new armrest device embodying the principles and concepts of an embodiment of the disclosure and generally designated by the reference numeral 10 will be described.

As best illustrated in FIGS. 1 through 5, the vehicle armrest device 10 generally comprises a support strap 12 which is positionable around a backrest 14 of a seat 16 in a vehicle 18. The seat 16 may be the driver's seat in the vehicle 18 and the vehicle 18 may be a passenger vehicle, a cargo vehicle or any other type of motorized vehicle which is commonly driven on public roadways. The support strap 12 is continuous such that the support strap 12 defines a closed loop thereby enabling the support strap 12 to fully extend around the backrest 14 of the seat 16. The support strap 12 includes a first sidelong portion 20 and a second sidelong portion 22 each extending between a front portion 24 and a rear portion 26. The front portion 24 is oriented parallel to the rear portion 26 and the first sidelong portion 20 is oriented parallel to the second sidelong portion 22. Furthermore, the support strap 12 is comprised of an elastomeric material thereby enabling the support strap 12 to be stretched around the backrest 14.

A first armrest 28 is provided and the first armrest 28 is attached to the support strap 12. The first armrest 28 is strategically positioned on the support strap 12 thereby enabling the first armrest 28 to be positioned upon a center console 30 of the vehicle 18 when the support strap 12 is positioned around the backrest 14 of the seat 16. In this way the first armrest 28 can support a right arm 32 of a driver 34 when the driver 34 is seated in the seat 16. The first armrest 28 includes a first panel 36 which has a lower surface 38 and an upper surface 40 and a perimeter edge 42 extending between the lower surface 38 and the upper surface 40. A rear side 44 of the perimeter edge 42 of the first panel 36 is attached to an intersection between the first sidelong portion 20 of the support strap 12 and the front portion 24 of the support strap 12. Additionally, the lower surface 38 of the first panel 36 rests upon the center console 30 when the support strap 12 is positioned around the backrest 14.

The first armrest 28 includes a first cushion 46 that has a bottom surface 48 which is attached to the upper surface 40 of the first panel 36 having the first cushion 46 completely covering the upper surface 40 of the first panel 36. In this way the driver's right arm 32 can be positioned on top of the first cushion 46. Furthermore, the first cushion 46 is comprised of a resiliently compressible material, including but not being limited to rubber or silicone, thereby enabling the first cushion 46 to enhance comfort for the driver 34. The first cushion 46 may be enclosed in a wrapping which might be comprised of leather, vinyl or other similar type of material to protect the first cushion 46 from becoming soiled or wet. Each of the first panel 36 and the first cushion 46 may have a width ranging between approximately 12.0 cm and 25.0 cm and a length ranging between approximately 20.0 cm and 30.0 cm.

The first armrest 28 includes a band 50 which has a first end 52 and a second end 54 and a first surface 56 extending between the first end 52 and the second end 54. The first surface 56 is attached to a first sidelong side 58 of the perimeter edge 42 of the first panel 36 at a point that is aligned with the first end 52 of the band 50. Additionally, the first surface 56 is attached to a second sidelong side 60 of the perimeter edge 42 of the first panel 36 at a point that is aligned with the second end 54 of the band 50. In this way the band 50 forms a closed loop which extends downwardly from the lower surface 38 of the first panel 36. Furthermore, the band 50 is centrally located between a front side 62 and a back side 64 of the perimeter edge 42 of the first panel 36. The band 50 is extendable around the center console 30 for securing the first panel 36 to the center console 30 and the band 50 is comprised of an elastomeric material thereby enabling the band 50 to be stretched around the center console 30.

A second armrest 66 provided and the second armrest 66 is attached to the support strap 12. The second armrest 66 is strategically positioned on the support strap 12 thereby enabling the second armrest 66 to be positioned between the seat 16 and a driver's side door 68 of the vehicle 18 when the support strap 12 is positioned around the backrest 14 of the seat 16. In this way the second armrest 66 can support the driver's left arm 70 when the driver 34 is seated in the seat 16. The second armrest 66 includes a second panel 72 which has a lower surface 74 and an upper surface 76 and a perimeter edge 78 extending between the lower surface 74 and the upper surface 76 of the second panel 72. A rear side 80 of the perimeter edge 78 of the second panel 72 is attached to an intersection between the second sidelong portion 22 of the support strap 12 and the front portion 24 of the support strap 12. Additionally, the lower surface 74 of the second panel 72 lies upon an arm rest 82 of the driver's side door 68 when the support strap 12 is positioned around the backrest 14 thereby enabling the second panel 72 to extend across the gap 84 between the arm rest 82 of the driver's side door 68 and the seat 16.

The second armrest 66 includes a second cushion 86 which has a bottom surface 88 that is attached to the upper surface 76 of the second panel 72. Additionally, the second cushion 86 completely covers the upper surface 76 of the second panel 72. In this way the driver's left arm 70 can be positioned on top of the second cushion 86. Furthermore, the second cushion 86 is comprised of a resiliently compressible material, including but not being limited to rubber or silicone, thereby enabling the second cushion 86 to enhance comfort for the driver 34. The second cushion 86 may be enclosed in a wrapping which might be comprised of leather, vinyl or other similar type of material to protect the second cushion 86 from becoming soiled or wet. Additionally, each of the second panel 72 and the second cushion 86 may have a width ranging between approximately 7.5 cm and 13.0 cm and a length ranging between approximately 20.0 cm and 30.0 cm.

In use, the support strap 12 is positioned around the backrest 14 of the seat 16 at a height that enables the first armrest 28 to be positioned on the center console 30 and that enables the second armrest 66 to be positioned on the arm rest 82 of the driver's side door 68. Additionally, the band 50 on the first armrest 28 is extended around a lid 90 of the center console 30 in the event that the center console 30 has a lid 90. In this way the driver 34 can position their right elbow 92 and forearm 94 on the first armrest 28 and the driver 34 can position their left elbow 96 and forearm 98 on the second armrest 66. Thus, the driver 34 can enjoy comfortable support for one or both of their arms while driving the vehicle 18. Furthermore, each of the first cushion 46 and the second cushion 86 are sufficiently thick and sufficiently dense to inhibit the driver's elbows from sinking into the first cushion 46 and the second cushion 86.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle armrest device being attachable to a seat in a vehicle for supporting each of a driver's arms, said device comprising:
a support strap being positionable around a backrest of a seat in a vehicle, said support strap being continuous such that said support strap defines a closed loop thereby enabling said support strap to fully extend around said backrest of said seat;
a first armrest being attached to said support strap, said first armrest being strategically positioned on said support strap thereby enabling said first armrest to be positioned upon a center console of said vehicle when said support strap is positioned around said backrest of said seat wherein said first armrest is configured to support a driver's right arm when the driver is seated in said seat; and
a second armrest being attached to said support strap, said second armrest being strategically positioned on said support strap thereby enabling said second armrest to be positioned between said seat and a driver's side door of said vehicle when said support strap is positioned around said backrest of said seat wherein said second armrest is configured to support the driver's left arm when the driver is seated in said seat.

2. The device according to claim 1, wherein:
said support strap includes a first sidelong portion and a second sidelong portion each extending between a front portion and a rear portion;
said front portion is oriented parallel to said rear portion;
said first sidelong portion is oriented parallel to said second sidelong portion;
said support strap is comprised of an elastomeric material thereby enabling said support strap to be stretched around said backrest;
said first armrest comprises a first panel having a lower surface and an upper surface and a perimeter edge extending between said lower surface and said upper surface;
a rear side of said perimeter edge of said first panel is attached to an intersection between said first sidelong portion of said support strap and said front portion of said support strap; and
said lower surface of said first panel lies upon said center console when said support strap is positioned around said backrest.

3. The device according to claim 2, wherein:
said first armrest includes a first cushion having a bottom surface being attached to said upper surface of said first panel having said first cushion completely covering said upper surface of said first panel wherein said first cushion is configured to have the driver's right arm positioned on top of said first cushion; and
said first cushion is comprised of a resiliently compressible material wherein said first cushion is configured to enhance comfort for the driver.

4. The device according to claim 2, wherein:
said first armrest includes a band which has a first end and a second end and a first surface extending between said first end and said second end;
said first surface is attached to a first sidelong side of said perimeter edge of said first panel at a point being aligned with said first end of said band;
said first surface is attached to a second sidelong side of said perimeter edge of said first panel at a point being aligned with said second end of said band such that said band forms a closed loop which extends downwardly from said lower surface of said first panel;
said band is centrally located between a front side and a back side of said perimeter edge of said first panel;
said band is extendable around said center console for securing said first panel to said center console; and
said band being comprised of an elastomeric material thereby enabling said band to be stretched around said center console.

5. The device according to claim 1, wherein:
said support strap includes a first sidelong portion and a second sidelong portion each extending between a front portion and a rear portion;
said front portion is oriented parallel to said rear portion;
said first sidelong portion is oriented parallel to said second sidelong portion;
said first armrest includes a first panel and a first cushion;
said second armrest comprises a second panel having a lower surface and an upper surface and a perimeter edge extending between said lower surface and said upper surface of said second panel;
a rear side of said perimeter edge of said second panel is attached to an intersection between said second sidelong portion of said support strap and said front portion of said support strap; and
said lower surface of said second panel lies upon an arm rest of the driver's side door when said support strap is positioned around said backrest thereby enabling said second panel to extend between said arm rest of said driver's side door and said seat.

6. The device according to claim 5, wherein:
said second arm rest includes a second cushion having a bottom surface being attached to said upper surface of said second panel having said second cushion completely covering said upper surface of said second panel wherein said second cushion is configured to have the driver's left arm positioned on top of said second cushion; and
said second cushion is comprised of a resiliently compressible material wherein said second cushion is configured to enhance comfort for the driver.

7. A vehicle armrest device being attachable to a seat in a vehicle for supporting each of a driver's arms, said device comprising:
a support strap being positionable around a backrest of a seat in a vehicle, said support strap being continuous such that said support strap defines a closed loop thereby enabling said support strap to fully extend around said backrest of said seat, said support strap including a first sidelong portion and a second sidelong portion each extending between a front portion and a rear portion, said front portion being oriented parallel to said rear portion, said first sidelong portion being oriented parallel to said second sidelong portion, said support strap being comprised of an elastomeric material thereby enabling said support strap to be stretched around said backrest;
a first armrest being attached to said support strap, said first armrest being strategically positioned on said support strap thereby enabling said first armrest to be positioned upon a center console of said vehicle when said support strap is positioned around said backrest of said seat wherein said first armrest is configured to support a driver's right arm when the driver is seated in said seat, said first armrest comprising:
a first panel having a lower surface and an upper surface and a perimeter edge extending between said lower surface and said upper surface, a rear side of said perimeter edge of said first panel being attached to an intersection between said first sidelong portion of said support strap and said front portion of said support strap, said lower surface of said first panel lying upon said center console when said support strap is positioned around said backrest;
a first cushion having a bottom surface being attached to said upper surface of said first panel having said first cushion completely covering said upper surface of said first panel wherein said first cushion is configured to have the driver's right arm positioned on top of said first cushion, said first cushion being comprised of a resiliently compressible material wherein said first cushion is configured to enhance comfort for the driver; and
a band having a first end and a second end and a first surface extending between said first end and said second end, said first surface being attached to a first sidelong side of said perimeter edge of said first panel at a point being aligned with said first end of said band, said first surface being attached to a second sidelong side of said perimeter edge of said first panel at a point being aligned with said second end of said band such that said band forms a closed loop which extends downwardly from said lower surface of said first panel, said band being centrally located between a front side and a back side of said perimeter edge of said first panel, said band being extendable around said center console for securing said first panel to said center console, said band being comprised of an elastomeric material thereby enabling said band to be stretched around said center console, and
a second armrest being attached to said support strap, said second armrest being strategically positioned on said support strap thereby enabling said second armrest to be positioned between said seat and a driver's side door of said vehicle when said support strap is positioned around said backrest of said seat wherein said second armrest is configured to support the driver's left arm when the driver is seated in said seat, said second armrest comprising:
a second panel having a lower surface and an upper surface and a perimeter edge extending between said lower surface and said upper surface of said second panel, a rear side of said perimeter edge of said second panel being attached to an intersection between said second sidelong portion of said support strap and said front portion of said support strap, said lower surface of said second panel lying upon an arm rest of the driver's side door when said support strap is positioned around said backrest thereby enabling said second panel to extend between said arm rest of said driver's side door and said seat; and
a second cushion having a bottom surface being attached to said upper surface of said second panel having said second cushion completely covering said upper surface of said second panel wherein said second cushion is configured to have the driver's left arm positioned on top of said second cushion, said second cushion being comprised of a resiliently compressible material wherein said second cushion is configured to enhance comfort for the driver.
